(19) United States
(12) Patent Application Publication
(10) Pub. No.: US 2005/0182927 A1
(43) Pub. Date: Aug. 18, 2005

(54) Multi-function solar cell in authentication token

(75) Inventor: Will Shatford, Pasadena, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: TRI-D SYSTEMS, INC.

(21) Appl. No.: 11/056,073

(22) Filed: Feb. 11, 2005

Related U.S. Application Data
(60) Provisional application No. 60/544,651, filed on Feb. 13, 2004.

(51) Int. Cl. H04L 9/00

(52) U.S. Cl. 713/159

(57) ABSTRACT

An authentication token that comprises a flexible solar cell array, a display, a processor, and a memory disposed in communication with the processor. Wherein the processor is configured to receive a signal from the flexible solar cell array, and, if the authentication token has been activated, compute a one-time passcode, and send the one-time passcode to the display. A device for communicating with the authentication token comprises a slot for receiving the authentication token; an optical character reader for recognizing characters on the display of the authentication token, and a hi-intensity strobe light for sending light pulses to the flexible solar cell array.

### CROSS-REFERENCE TO A RELATED APPLICATION

This application for letters patent is related to and incorporates by reference provisional application Ser. No. 60/544,651, titled “Multi-Function Solar Cell in Authentication Token,” and filed in the United States Patent and Trademark Office on Feb. 13, 2004.

### FIELD OF THE INVENTION

The present invention relates, in general, to computer hardware security devices. In particular, the present invention is a hardware authentication token that incorporates flexible solar cell technology as a power source, event trigger, and communication interface.

### BACKGROUND OF THE INVENTION

A solar cell is typically used to power a device or detect the presence of light. Prior art solar cells are multi-layer fabrications that typically include a power conductor layer, a p-type silicon layer, an n-type silicon layer, a ground conductor grid layer, and an anti-reflective coating layer. Recent advances in solar cell technology and nanotechnology have allowed solar cells to be constructed from plastic and organic materials. These flexible solar cells easily fit within the form factor of a credit card, smart card, or other portable device and are attractive because they are flexible, significantly thinner than their silicon-based predecessor, and efficient. These characteristics have permitted the use of flexible solar cells in applications that were not possible with the prior art glass-based solar cell products.

Authentication is the process of identifying an individual to ensure that they are who they claim to be. Typically, a computer system authenticates each individual entering the system by requiring them to enter a username and a password. This is referred to as one-factor authentication or authentication based on something you know. Recently, some computer systems have begun to authenticate each individual entering the system by requiring them to use something they have (e.g., a hardware authorization token) combined with something they know (e.g., a personal identification number). This is referred to as two-factor authorization.

A hardware authorization token, such as the SecurID Token from RSA Security, Inc. or the credit card device from TRI-D, is a computing device that periodically generates a random number. In a computer system that uses two-factor authorization, an individual entering the system would combine the random number generated by the hardware authentication token (something they have) with a personal identification number (something they know) to gain entry to the system. A disadvantage of the hardware authentication token is the inability to verify the identity of the individual holding the token before releasing the random number. Another disadvantage of the hardware authentication token is battery management and replacement, and power management.

Thus, there is a need for a hardware authentication token that incorporates flexible solar cell technology. The present invention addresses this need.

### SUMMARY OF THE INVENTION

An authentication token that comprises a flexible solar cell array, a display, a processor, and a memory disposed in communication with the processor. Wherein the processor is configured to receive a signal from the flexible solar cell array, and, if the authentication token has been activated, compute a one-time passcode, and send the one-time passcode to the display. A device for communicating with the authentication token comprises a slot for receiving the authentication token; an optical character reader for recognizing characters on the display of the authentication token, and a hi-intensity strobe light for sending light pulses to the flexible solar cell array.

Additional objects, advantages, and novel features of the invention will be set forth in part in the description, examples, and figures which follow, all of which are intended to be for illustrative purposes only, and not intended in any way to limit the invention, and in part will become apparent to the skilled in the art on examination of the following, or may be learned by practice of the invention.

### BRIEF DESCRIPTION OF THE DRAWINGS

The accompanying figures illustrate details of the hardware authentication token that incorporates flexible solar cell technology. Reference numbers and designations that are alike in the accompanying figures refer to like elements.

FIG. 1 is a block diagram that illustrates an exemplary embodiment of a credit card authentication token.

FIG. 2 is a block diagram that illustrates an exemplary embodiment of a smart card authentication token.

FIG. 3 is a block diagram that illustrates an exemplary embodiment of components that comprise an exemplary authentication token.

FIG. 4 is a block diagram that illustrates an exemplary terminal for communication with the authentication token shown in FIG. 3.

FIG. 5 is a block diagram that illustrates a cutaway view of the terminal shown in FIG. 4 with the authentication token inserted.

### DETAILED DESCRIPTION OF THE INVENTION

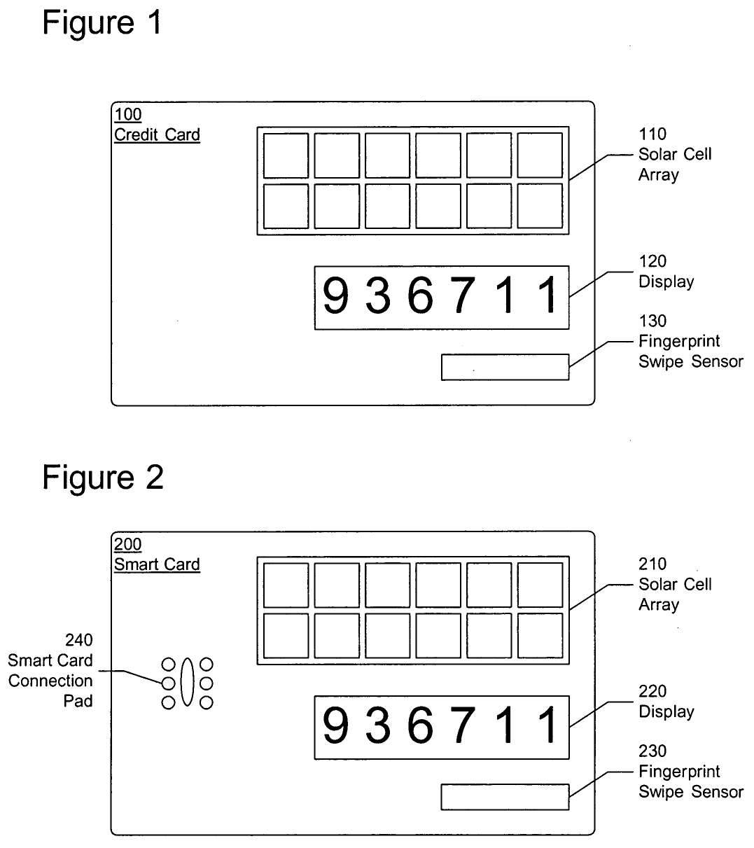

FIG. 1 illustrates an exemplary embodiment of a credit card authentication token. Credit card 100 is a standard credit card measuring approximately three and three-eighths inches by two and one-eighth inches in size and is approximately one thirty-second inch thick. Credit card 100 is flexible and durable because it is manufactured from a plastic material such as polycarbonate, polyvinylchloride (PVC), polyester (PET), or similar material.

Credit card 100 comprises a solar cell array 110, display 120, and fingerprint swipe sensor 130, which are embedded in the credit card 100 and do not add to the thickness of credit card 100. The solar cell array 110 is a flexible and thin power source for the credit card 100 and fabricated from a plastic material or an organic material. In one embodiment, the solar cell array 110 measures 1 centimeter by 7 centimeters in size. The display 120 is a flexible and thin visual communication device for credit card 100 that displays a one-time passcode to the card holder. The fingerprint swipe sensor 130 is a standard, reinforced fingerprint sensor or a flexible and thin device for verifying the identity of the card holder before generating a one-time passcode.

FIG. 2 illustrates an exemplary embodiment of a smart card authentication token. Smart card 200 is a standard smart card measuring approximately same size as a standard credit card. Smart card 200 is flexible and durable because it is manufactured from a plastic material such as polycarbonate, polyvinylchloride (PVC), polyester (PET), or similar material.

The smart card 200 comprises a solar cell array 210, display 220, fingerprint swipe sensor 230, and smart card connection pad 240, which are embedded in the smart card 200 and do not add to the thickness of smart card 200. The solar cell array 210 is a flexible and thin power source for the smart card 200 and fabricated from a plastic material, such as a polymer, or an organic material. In one embodiment, the solar cell array 210 measures 1 centimeter by 7 centimeters in size. The display 220 is a flexible and thin visual communication device for smart card 200 that displays a one-time passcode to the card holder. The fingerprint swipe sensor 230 is a standard, reinforced fingerprint sensor or a flexible and thin device for verifying the identity of the card holder before generating a one-time passcode. The smart card connection pad 240 is the communication device that allows the smart card 200 to communicate with a smart card reader (not shown).

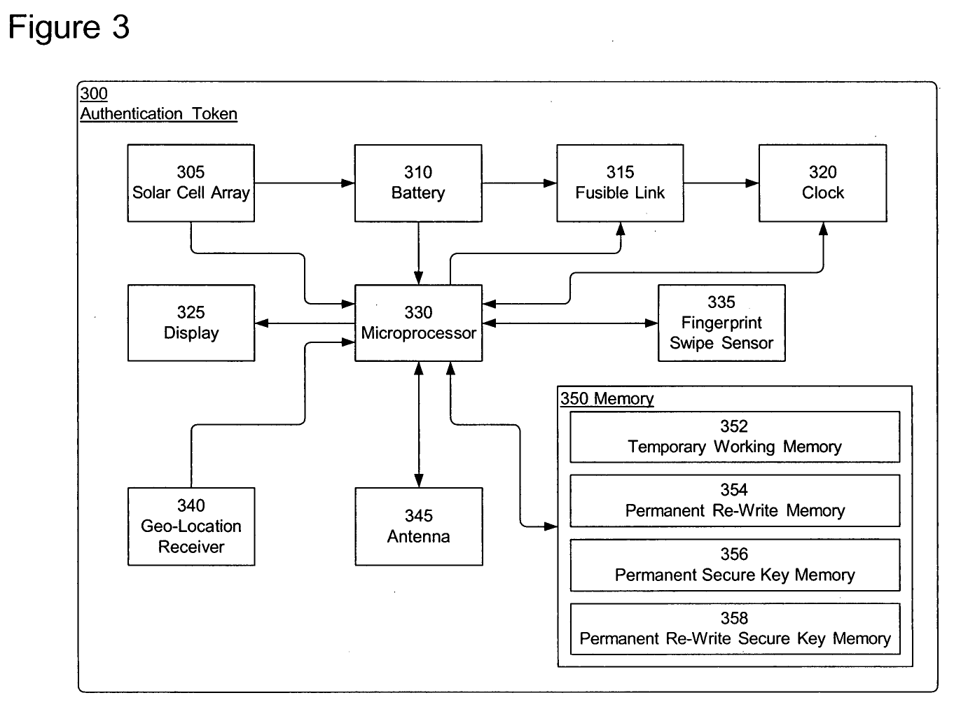

FIG. 3 illustrates an exemplary embodiment of components that comprise an exemplary authentication token. The authentication token 300 shown in FIG. 3 comprises a solar cell array 305, battery 310, fusible link 315, clock 320, display 325, microprocessor 330, fingerprint swipe sensor 335, geo-location receiver 340, antenna 345, and memory 350. The memory 350 further comprises a temporary working memory 352, permanent re-write memory 354, permanent secure key memory 356, and permanent re-write secure key memory 358.

The solar cell array 305 is the trigger to activate the functions performed by the authentication token 300. A card holder activates the solar cell array 305 by exposing it to a sufficiently activating light, for example, by removing the authentication token 300 from a wallet, purse, or blackout container or the like, or by covering the solar cell array 305 for a short time period when the card is in a lighted environment. The solar cell array 305 on the exemplary authentication token 300 shown in FIG. 3 can support functions, such as initial activation and enrollment of the authentication token 300, proper initialization of the authentication token 300 before each use, powering the authentication token 300 or providing supplemental power to the authentication token 300, recharging the battery 310 on the authentication token 300, and providing a connectionless interface for configuration and administration of the authentication token 300.

The activation of the authentication token 300 requires an interface with the token. Since credit card-based tokens typically do not include any physical connections, the solar cell array 305 can be used for this function. Light hitting the solar cell array 305 triggers the solar cell array 305 to send a “wake-up” signal and power to the microprocessor 330. The microprocessor 330, a management processor, will review its memory 350. If the memory 350 state indicates that the authentication token 300 has not been activated, the microprocessor 330 will start the full activation and enrollment process. Following completion of the full activation and enrollment process, the microprocessor 330 will update the state of memory 350 to indicate that the authentication token 300 is activated and the card holder is enrolled. If the card holder places the solar cell array 305 in a dark, or blackout, environment before the microprocessor 330 updates the state of the memory 350, the activation and enrollment process will begin anew the next time the token is removed from the blackout environment (exposed to light).

In the embodiment shown in FIG. 3, the initial activation of the authentication token 300 may also need to connect the battery 310 for the first time. During the activation and enrollment process, the process fuses the fusible link 315 to permanently connect the battery 310 to the clock 320. As shown in FIG. 3, the real-time clock 320 and microprocessor 330 are separate. However, these components may be combined in other embodiments. Fusing the link during the initial activation and enrollment of the authentication token 300 is a battery saving measure. The battery 310 does not need to be connected during manufacture of the authentication token 300, thereby alleviating any drain on the battery 310 until the card holder is ready to use the card. This increases the storage life of the authentication token 300 and mitigates the impact of delays in delivery of the authentication token 300 to the card holder.

Each time the card holder uses the authentication token 300 to gain entry to a computer system it may be necessary to initialize the authentication token 300. This will be particularly important in battery-powered tokens where the authentication token 300 may go into a very low power standby or sleep mode when the authentication token 300 is not in use for a pre-determined period of time. This should not be inconvenient for the card holder since the authentication token 300 will typically be used only a few times a day and put away (in a wallet, purse, pocket, desk, etc.) after the microprocessor 330 displays an authentication code on display 325. Exposing the solar cell to light can cause the authentication token 300 to wakeup into a fully functioning mode.

For authentication tokens that require very little power, the solar cell can be the primary, or only, source of power. In the embodiment shown in FIG. 3, authentication token 300 includes battery 310 to maintain very low power real-time clocks or very low power receivers when the solar cell array 305 is not in a lighted environment. In another embodiment, the authentication token 300 may periodically require more power than can be supplied by just the solar cell array 305. Thus, battery 310 is selected to meet the peak power requirements and the solar cell array 305 provides power for the activation signal or, optionally also provides a supplemental source of power.

In one embodiment, the battery 310 is rechargeable. Since the solar cell array 305 can function as a supplemental source of power, the solar cell array 305 can provide a trickle current that will recharge the battery 310 or keep the battery 310 fully charged. This may be especially helpful when the authentication token 300 goes into a standby or sleep mode and does not require much power. In this case, the excess power from the solar cell array 305 is available to charge the battery 310. For an authentication token 300 designed to enter a sleep mode, simply covering the solar cell array 305 for a few seconds, and then uncovering the solar cell array 305, will cause the authentication token 300 to wakeup. As an added advantage, if the solar cell array 305 can provide enough power to charge the battery 310 while the token is awake, then a sleep mode may not be necessary as long as a trickle charge is present.

After light triggers the solar cell array 305 to activate the microprocessor 330, the microprocessor 330 sends a signal to wake-up other heavy-duty devices present on the authentication token 300. For example, although without intended limitation, the embodiment shown in FIG. 3 includes two heavy-duty devices, fingerprint swipe sensor 335, and geo-location receiver 340 and antenna 345. The heavy-duty devices shown in FIG. 3 are exemplary and not intended to exclude similar heavy-duty devices.

The fingerprint swipe sensor 335 is a fingerprint capture device appropriate for a credit card device such as the authentication token 300. If the card holder does not use the fingerprint swipe sensor 335 within a given time period after activation, the microprocessor 330 will signal the fingerprint swipe sensor 335 to power down, thereby reducing the power drain on the battery 310. If the card holder uses the fingerprint swipe sensor 335 within the given time period, the microprocessor 330 stores the captured fingerprint image in the memory 350, compares the captured fingerprint image to a known image retrieved from the card holder during initial activation of the authentication token 300, and verifies whether the card holder is the appropriate and authorized user of the authentication token 300. In one embodiment, the authentication token 300 includes a separate fingerprint processor (not shown) that is more capable to perform the image retrieval and comparison.

The geo-location receiver 340 and antenna 345 function as a position locator device appropriate for a credit card device such as the authentication token 300. The position locator device may include a global positioning satellite device, or a cellular network locator. If the card holder does not use the position locator device within a given time period after activation, the microprocessor 330 signals the position locator device to power down, thereby reducing the power drain on the battery 310. If the card holder uses the position locator device within the given time period, the microprocessor 330 receives a position location via the antenna 345, stores the position in the memory 350, and displays the position information to the card holder via the display 325 or incorporate this information into the generation of the one-time passcode displayed to the user via the display 325.

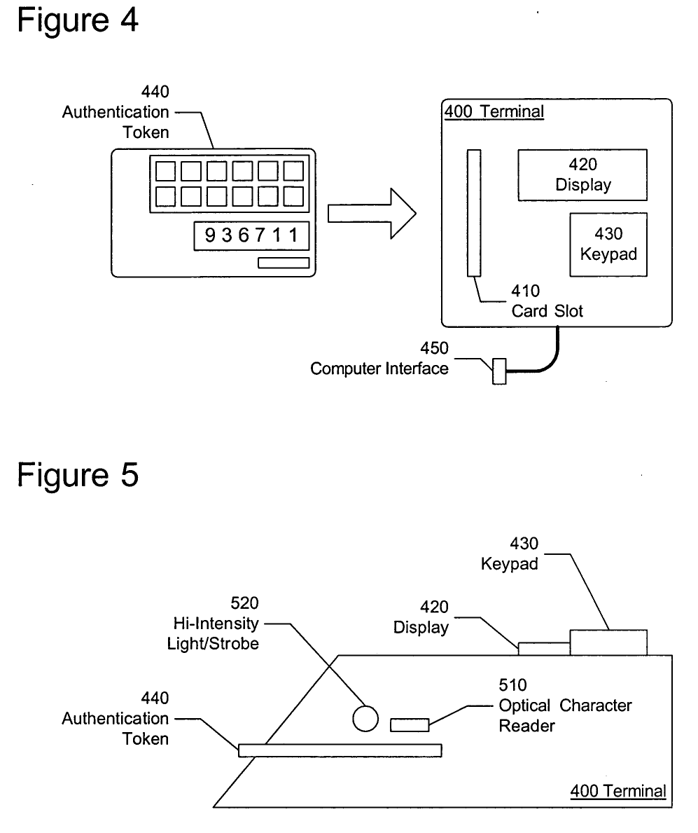

FIG. 4 illustrates an exemplary terminal for communication with the authentication token shown in FIG. 3. The terminal 400 shown in FIG. 4 comprises a card slot 410, display 420, and keypad 430. In one embodiment, the terminal 400 further comprises a computer interface 450 to a general-purpose computer.

The solar cell array 310 can be used to communicate with the authentication token 300. For authentication tokens in a form which does not have a corresponding physical terminal, the solar cell array 310 can be used to program the authentication token 300, reset the authentication token 300, or for other general communication with the authentication token 300. However, these functions require a special communications terminal, such as terminal 400 shown in FIG. 4. As shown in FIG. 4, the card holder inserts a credit card type authentication token 440 into a special card slot 410 in the terminal 400. A NRZ (non-return to zero) pulsed light communications protocol will provide both power and data to the token. Display 420 and keypad 430 are visual and manual communication devices, respectively, for the card holder.

FIG. 5 illustrates a cutaway view of the terminal shown in FIG. 4 with the authentication token inserted. The cutaway view shows that terminal 400 further comprises an optical character reader 510 and hi-intensity light/strobe 520 to support two-way communication between the authentication token 440 and the card holder. When authentication token 440 is inserted into terminal 400, the optical character reader 510 reads the characters on the authentication token 440 display to receive communication messages from the authentication token 440. Similarly, the hi-intensity light/strobe 520 sends light pulses to the solar cell array on the authentication token 440 to send communication messages to the authentication token 440.

This communications capability is especially important for mass production of the authentication tokens. Special data, such as an encryption key, can be programmed into the token after it has been manufactured, but before delivery to a card holder. A clock on the token can be enabled and set before delivery to a user. Even the battery on the token can be logically disconnected until the token is enabled.

This communications capability is also important for maintenance of the authentication tokens. A person authorized to administer the token will be able to reset a token if it appears to not be working or for re-issue to a different user. The administrator can be given a number of “blank” tokens to be programmed just before issuing to a user. The clock-reset option will restart a clock on the authentication token and re-sync the authentication token with the computer system that the card holder will access using the authentication token.

The communications protocol must be secure. The token may contain a generic or batch produced encryption key that will be issued to the administrator. This key will be needed to communicate with the token and can be permanently deactivated once the unique key of the user has been programmed onto the token.

The communication protocol can also be used to obtain information from the token. This can include the current date/time on the token, the number of times the token has been used, the last time it was used, and status information about the token, such as the voltage in the battery.

Although the disclosed embodiments describe a fully functioning hardware authentication token that incorporates flexible solar cell technology, the reader should understand that other equivalent embodiments exist. Since numerous modifications and variations will occur to those reviewing this disclosure, the hardware authentication token that incorporates flexible solar cell technology is not limited to the exact construction and operation illustrated and disclosed. Accordingly, this disclosure intends all suitable modifications and equivalents to fall within the scope of the claims.

1. An authentication token, comprising:
a flexible solar cell array;
a display;
a processor; and
a memory disposed in communication with the processor, the processor configured to:
receive a signal from the flexible solar cell array; and
if the authentication token has been activated:
compute a one-time passcode; and
send the one-time passcode to the display.

2. The authentication token of claim 1, wherein the flexible solar cell array sends the signal when the flexible solar cell array passes from a dark environment to a light environment.

3. The authentication token of claim 1, further comprising:
a fingerprint capture device.

4. The authentication token of claim 3, wherein if the authentication token has not been activated, the processor is further configured to:
send a power-on signal to the fingerprint capture device;
receive an image from the fingerprint capture device; and
store the image as a known fingerprint.

5. The authentication token of claim 4, wherein the processor signals a separate processor, and the separate processor receives the image, and stores the image.

6. The authentication token of claim 1, wherein to determine whether the authentication token has been activated further comprises:
accessing the memory; and
determining whether the memory stores a secure key.

7. The authentication token of claim 1, wherein if the authentication token has been activated, the processor further configured to:
send a power-on signal to at least one heavy duty device; and
send a power-off signal to each said at least one heavy duty device that is idle for a period of time after sending the power-on signal.

8. The authentication token of claim 7, wherein the heavy duty device is a geo-location device, the processor further configured to:
receive a position location from an antenna; and
send the position location to the display or incorporate the position location into the one-time passcode.

9. The authentication token of claim 1, further comprising:
a battery to provide power for the authentication token.

10. The authentication token of claim 9, wherein the battery supplements the power generated by the flexible solar cell array.

11. The authentication token of claim 9, wherein the battery is a rechargeable battery, and wherein a portion of the power generated by the solar cell array that is in excess of the power required to operate the authentication token is diverted to the rechargeable battery.

12. The authentication token of claim 1, wherein if the authentication token has been activated, the processor is further configured to:
send communication messages to a terminal device; and
receive communication messages from the terminal device.

13. The authentication token of claim 12, wherein the display sends the communication messages to the terminal device, and wherein the flexible solar cell array receives the communication messages from the terminal device.

14. The authentication token of claim 12, wherein the communication messages sent to the terminal device and the communication messages received by the terminal device function to program the authentication token, initialize the authentication token, reset the authentication token, or check the status of the authentication token.

15. A device for communicating with an authentication token, comprising:
a slot for receiving an authentication token that includes a flexible solar cell array, and a display;
an optical character reader for recognizing characters on the display; and
a hi-intensity strobe light for sending light pulses to the flexible solar cell array.

16. The device of claim 15, wherein the optical character reader receives communication messages from the authentication token, and wherein the hi-intensity strobe light sends communication messages to the authentication token.

17. The device of claim 16, wherein the communication messages sent to the authentication token and the communication message received by the authentication token function to program the authentication token, initialize the authentication token, reset the authentication token, or check the status of the authentication token.

18. The device of claim 15, further comprising:
an interface to a general-purpose computer.

19. The device of claim 15, further comprising:
a user display; and
a user keypad,
wherein a user operates the user display and the user keyboard to direct the device to program the authentication token, initialize the authentication token, reset the authentication token, or check the status of the authentication token.
